(19) United States
(12) Patent Application Publication
(10) Pub. No.: US 2013/0038852 A1
(43) Pub. Date: Feb. 14, 2013

(54) RETICLE REMOVING APPARATUS AND RETICLE REMOVING METHOD USING THE SAME

(71) Applicants: Ee-Yian TOH, Singapore (SG); Ren-Wei Peng, Singapore (SG)

(72) Inventors: Ee-Yian TOH, Singapore (SG); Ren-Wei Peng, Singapore (SG)

(73) Assignee: UNITED MICROELECTRONICS CORPORATION, Hsinchu (TW)

(21) Appl. No.: 13/205,885

(22) Filed: Aug. 9, 2011

(51) Int. Cl. G03B 27/72

(52) U.S. Cl. 355/71

(57) ABSTRACT

A reticle removing apparatus adapted to remove a reticle in a reticle library of an exposure apparatus is provided. The reticle removing apparatus includes a bracket and a reticle removing module movably coupled to the bracket, wherein the reticle removing module is configured to be moved into the reticle library in a first direction to remove the reticle in the reticle library. A reticle removing method using the reticle removing apparatus is also provided.

### FIELD OF THE INVENTION

The present invention relates to a removing apparatus, and particularly to a reticle removing apparatus for removing a reticle in a reticle library of an exposure apparatus and a reticle removing method using the reticle removing apparatus.

### BACKGROUND OF THE INVENTION

The scanning exposure apparatus is used in a lithography process in the manufacturing of semiconductor devices, liquid crystal display devices or the like. The scanning exposure apparatus includes a reticle library for receiving a plurality of reticles. When the scanning exposure apparatus functions, the removal of the reticles is automatically performed by the scanning exposure apparatus.

However, when the scanning exposure apparatus malfunctions, the reticles stuck in the reticle library need to be removed outside the reticle library by manual operation. In the conventional technique, because the space for receiving the reticles is tiny and there is no suitable reticle removing apparatus for the operator, the reticles may be impacted or the like during the manual removal. Therefore, the reticles are easily damaged during the manual removal.

### SUMMARY OF THE INVENTION

The present invention provides a reticle removing apparatus to prevent a reticle in a reticle library of an exposure apparatus from being damaged during a manual removal.

The present invention further provides a reticle removing method to prevent a reticle in a reticle library of an exposure apparatus from being damaged during a manual removal.

The present invention provides a reticle removing apparatus adapted to remove a reticle in a reticle library of an exposure apparatus. The reticle removing apparatus includes a bracket and a reticle removing module movably coupled to the bracket, wherein the reticle removing module is configured to be moved into the reticle library in a first direction to remove the reticle in the reticle library.

In an embodiment of the present invention, the reticle removing module includes a base and a gripper. The base is movably coupled to the bracket and provided with a sliding track. The gripper is movably coupled to the base and adapted to be slid along the sliding track into the reticle library to remove the reticle in the reticle library.

In an embodiment of the present invention, the bracket includes two opposite fixed elements, the base includes two opposite track elements respectively coupled to the two fixed elements, and the sliding track is provided by the track elements.

In an embodiment of the present invention, the gripper includes two arms and a connection part. The two arms are coupled to the two track elements respectively and configured to be slid along the sliding track into the reticle library to remove the reticle in the reticle library. The connection part is connected to the two arms.

In an embodiment of the present invention, each of the arms is provided with at least a roller coupled to the corresponding sliding track.

In an embodiment of the present invention, a first end of each of the arms is provided with a stop block, the connection part is connected to a second end of each of the two arms, and the first end is opposite to the second end.

In an embodiment of the present invention, the reticle library includes a plurality of supporting layers stacked in a second direction, each of the supporting layers is configured for supporting the reticle, and the base is suitable to be moved in the second direction to level at one of the supporting layers.

In an embodiment of the present invention, each of the fixed elements is a fixed column parallel to the second direction, the bracket further includes two fasteners respectively coupled to the fixed elements, and each of the track elements is coupled to the corresponding fixed element through one of the fasteners.

In an embodiment of the present invention, each of the track elements is pivoted to the corresponding fastener.

In an embodiment of the present invention, the bracket further includes a platform and a reticle holder disposed on the platform.

In an embodiment of the present invention, the reticle removing apparatus further includes a suction module. The suction module includes a suction element and a vacuum tank coupled to the suction element. The suction element is configured for sucking a reticle in the exposure apparatus but outside the reticle library.

In an embodiment of the present invention, the reticle library includes a plurality of supporting layers stacked in a second direction, the bracket includes a plurality of track layers stacked in the second direction and respectively leveled at the supporting layers, and the reticle removing module is movably coupled to one of the track layers.

In an embodiment of the present invention, the bracket is configured to be connected with the reticle library to communicate the track layers with the supporting layers.

In an embodiment of the present invention, the reticle removing apparatus further includes a fixing unit configured to fix the bracket to the reticle library.

In an embodiment of the present invention, the reticle removing module includes a base and a gripper. The base is movably coupled to one of the track layers and adapted to be slid along the corresponding track layer. The gripper is coupled to the base and adapted to be slid with the base and into the reticle library to remove the reticle in the reticle library.

In an embodiment of the present invention, the base includes two first arms and a first connection part connected to the two first arms, the gripper includes two second arms and a second connection part connected to the two second arms, and each of the second arms is separably coupled to the corresponding first arm.

In an embodiment of the present invention, the base further includes a first handle connected to the first connection part, and the gripper further includes a second handle connected to the second connection part.

In an embodiment of the present invention, each of the first arms is provided with at least a coupling track and each of the second arms is provided with at least a pillar coupled to the coupling track.

The present invention further provides a reticle removing method adapted to remove a reticle in a reticle library of an exposure apparatus. The reticle removing method includes following steps. A reticle removing apparatus is provided, wherein the reticle removing apparatus includes a bracket and a reticle removing module movably coupled to the bracket. Then, the reticle removing module is moved into the reticle library in a first direction to remove the reticle in the reticle library.

In an embodiment of the present invention, the reticle library includes a plurality of supporting layers stacked in a second direction, and each of the supporting layers is configured for supporting the reticle. The reticle removing method further includes a step of adjusting a position of the reticle removing module in a second direction to level at the one of the supporting layers before moving the reticle removing module into the reticle library.

In the present invention, the operator can use reticle removing module to smoothly remove the reticle stuck in the reticle library so as to prevent the reticle from being damaged during the manual removal. Moreover, due to using the reticle removing apparatus to remove the reticle stuck in the reticle library, the reticle removing method can prevent the reticle from being damaged during the manual removal.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic three-dimensional view showing a combination structure of a reticle library and a reticle removing apparatus according to an embodiment of the present invention;

FIG. 2 is a schematic exploded view of FIG. 1;

FIG. 3 is a schematic three-dimensional view of a reticle library and a reticle removing apparatus according to another embodiment of the present invention;

FIG. 4 is a schematic view showing a fastener coupled to a fixed element according to an embodiment of the present invention; and

FIG. 5 is a schematic three-dimensional view of a reticle removing apparatus according to another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

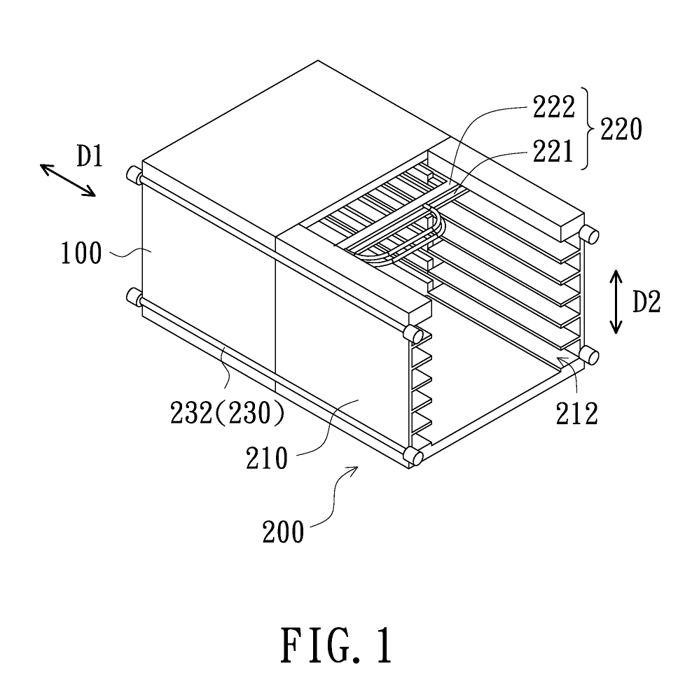

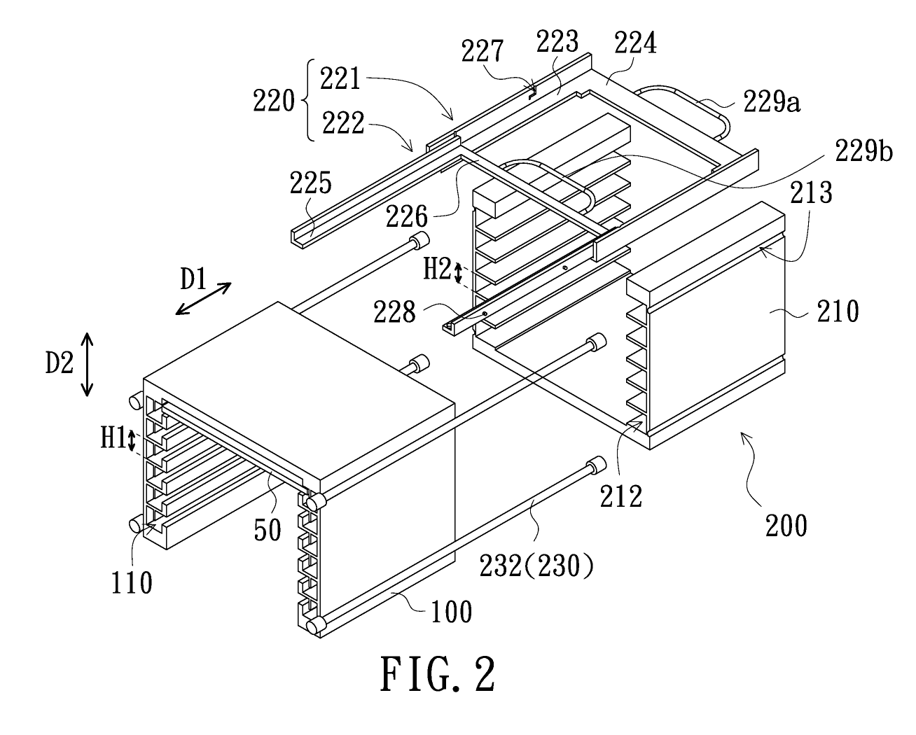

FIG. 1 is a schematic three-dimensional view showing a combination structure of a reticle library and a reticle removing apparatus according to an embodiment of the present invention, and FIG. 2 is a schematic exploded view of FIG. 1. Referring to FIGS. 1 and 2, the reticle removing apparatus 200 is used to remove the reticle 50 stuck in a reticle library 100 of an exposure apparatus (not shown) such as a scanning exposure apparatus when the exposure apparatus malfunctions. The reticle removing apparatus 200 includes a bracket 210 and a reticle removing module 220 movably coupled to the bracket 210. The reticle removing module 220 is configured to be moved into the reticle library 100 in a first direction D1 to remove the reticle 50 in the reticle library 100.

More specifically, the reticle library 100 may include a plurality of supporting layers 110 stacked in a second direction D2. In one embodiment, a height H1 of each supporting layer 110 may be about 18.8 millimeters, and each supporting layer 110 may be capable of supporting the reticle 50 with a thickness equal to or smaller than 9.5 millimeters. Furthermore, the bracket 210 may include a plurality of track layers 212 stacked in the second direction D2 and respectively leveled at the supporting layers 110. That is, each of the track layers 212 is corresponded to one of the supporting layers 110 and leveled at the corresponding supporting layer 110. Therefore, a height H2 of each track layer 212 may be the same with the height H1 of each supporting layer 110. The bracket 210 may be connected with the reticle library 100 to communicate the track layers 212 with the supporting layers 110. In the present embodiment, the reticle removing apparatus 200 may further include a fixing unit 230 configured to fix the bracket 210 to the reticle library 100. The fixing unit 230 may include a plurality of clamping posts 232, wherein each of the clamping posts 232 is configured to clamp the reticle library 100 and the bracket 210. The bracket 210 may be provided with grooves 213 for receiving the clamping posts 232, and the reticle library 100 may also be provided with grooves (not shown) for receiving the clamping posts 232.

The reticle removing module 220 is movably coupled to one of the track layers 212. More specifically, the reticle removing module 220 may include a base 221 and a gripper 222. The base 221 is movably coupled to one of the track layers 212 and adapted to be slid along the corresponding track layer 212 in the first direction D1. The gripper 222 is coupled to the base 221 and adapted to be slid with the base 221 and into the reticle library 100 to remove the reticle 50 in the reticle library 100. The base 221 may include two first arms 223 and a first connection part 224 connected to the two first arms 223, the gripper 222 may include two second arms 225 and a second connection part 226 connected to the two second arms 225, and each of the second arms 225 is separably coupled to the corresponding first arm 223. In the present embodiment, each of the first arms 223 may be provided with at least a coupling track 227 (two are shown in FIG. 2) and each of the second arms 225 may be provided with at least a pillar 228 (two are shown in FIG. 2) coupled to the coupling track 227. Moreover, the base 221 may further include a first handle 229a connected to the first connection part 224, and the gripper may further include a second handle 229b connected to the second connection part 226. In another embodiment, the first handle 229a and the second handle 229b can be omitted, and the first connection part 224 and the second connection part 226 can be served as handles.

A reticle removing method using the reticle removing apparatus 200 will be described herein. The reticle removing method includes providing the reticle removing apparatus 200. Then, the reticle removing module 220 is moved into the reticle library 100 in the first direction D1 to remove the reticle 50 in the reticle library 100. In detail, before moving the reticle removing module 220 into the reticle library 100, a position of the reticle removing module 220 in the second direction D2 may be adjusted to level at the one of the supporting layers 112. For example, while removing the reticle 50 in the uppermost supporting layer 112, the reticle removing module 220 may be firstly put in the uppermost track layer 212. After, the reticle removing module 220 is moved into the reticle library 100 in the first direction D1, and the reticle removing module 220 is under the reticle 50. Then, the gripper 222 may be slightly lifted up in the second direction D2 so as to grip the reticle 50. Afterwards, the reticle removing module 220 is moved outside the reticle library 100 in the first direction D1 so as to remove the reticle 50 in the reticle library 100.

In the present embodiment, the operator can use the reticle removing module 220 to smoothly remove the reticle 50 stuck in the reticle library 100 so as to prevent the reticle 50 from being impacted or the like. Therefore, the reticle removing apparatus 200 and the reticle removing method can prevent the reticle 50 from being damaged during the manual removal.

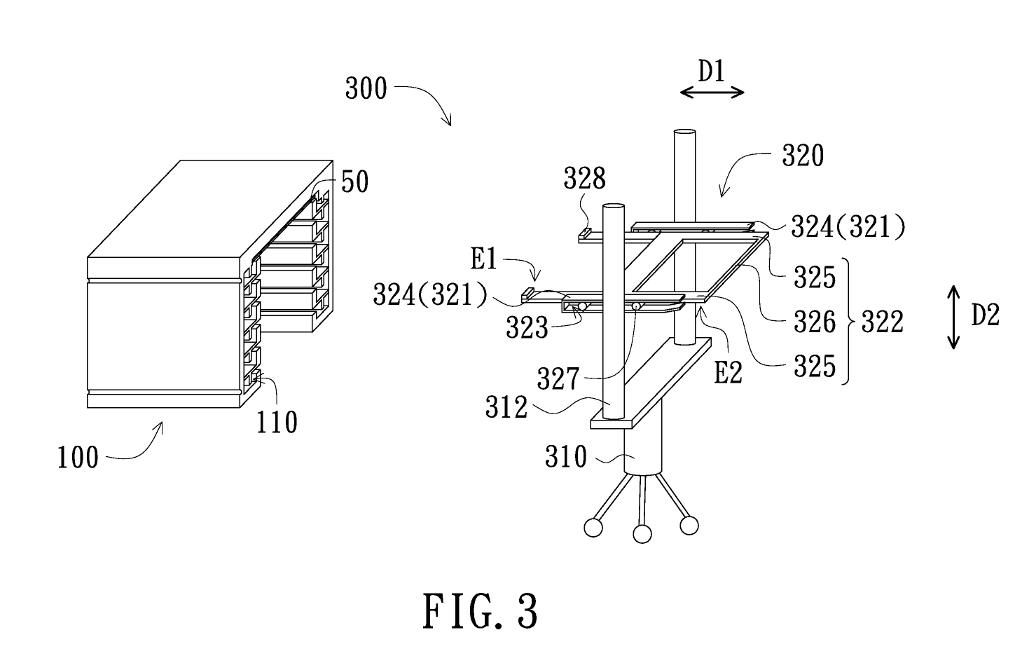

FIG. 3 is a schematic three-dimensional view of a reticle library and a reticle removing apparatus according to another embodiment of the present invention. Referring to FIG. 3, the reticle removing apparatus 300 includes a bracket 310 and a reticle removing module 320 movably coupled to the bracket 310. The reticle removing module 320 is configured to be moved into the reticle library 100 in a first direction D1 to remove the reticle 50 in the reticle library 100.

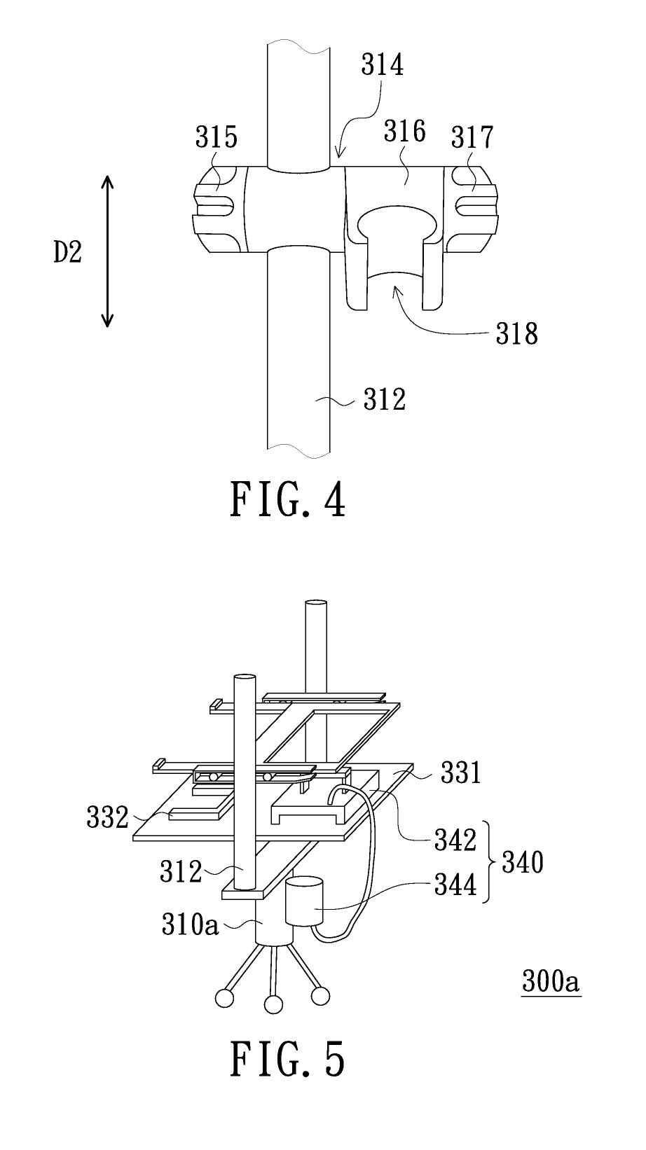

The reticle removing module 320 may include a base 321 and a gripper 322. The base 321 is movably coupled to the bracket 310 and provided with a sliding track 323. The bracket 310 may include two opposite fixed elements 312, the base 321 may include two opposite track elements 324 respectively coupled to the two fixed elements 312, and the sliding track 323 is provided by the track elements 324. In detail, each of the fixed elements 312 may be a fixed column parallel to a second direction D2, the bracket 310 may further include two fasteners 314 as shown in FIG. 4. The two fasteners 314 are respectively coupled to the fixed elements 312, and each of the track elements 324 is coupled to the corresponding fixed element 312 through one of the fasteners 314. That is, each track element 324 is fixed to the corresponding fastener 314 so as to be coupled to the corresponding fixed element 312.

The fastener 314, for example, includes a fastening knob 315. When the fastening knob 315 is tightened, the fastener 314 is fixed to the fixed element 312. When the fastening knob 315 is loosened, the fastener 314 can be moved along the fixed elements 312 so as to adjust the position of the base 321 in the second direction D2, and thus the base 321 is suitable to be moved in the second direction D2 to level at one of the supporting layers 110. Moreover, each of the track elements 324 may be pivoted to the corresponding fastener 314. In detail, the fastener 314 may further include a rotating member 316 and a fastening knob 317. The rotating member 316 is pivoted to a shaft (not shown) of the fastener 314, and the track element 324 is fixed to the rotating member 316. In the present embodiment, the track element 324 may be provided with a join portion (not shown) joined with a join portion 318 of the rotating member 316. When the fastening knob 317 is tightened, the rotating member 316 is not rotated. When the fastening knob 317 is loosened, the rotating member 316 can be rotated so as to rotate the reticle removing module 320.

The gripper 322 is movably coupled to the base 321 and adapted to be slid along the sliding track 323 into the reticle library 100 to remove the reticle 50 in the reticle library 100. The gripper may include two arms 325 and a connection part 326. The two arms 325 are coupled to the two track elements 324 respectively and configured to be slid along the sliding track 323 into the reticle library 100 to remove the reticle 50 in the reticle library 100. The connection part 326 is connected to the two arms 324. The connection part 326 can be served as a handle. In another embodiment, an additional handle (not shown) may be connected to the connection part 326.

Each of the arms 324 may be provided with at least a roller 327 (two are shown in FIG. 3) coupled to the corresponding sliding track 324. Moreover, a first end E1 of each of the arms 324 may be provided with a stop block 328, the connection part 326 may be connected to a second end E2 of each of the two arms 324, and the first end E1 is opposite to the second end E2. The stop block 328 can limit the position of the reticle 50 on the two arms 324.

A reticle removing method using the reticle removing apparatus 300 will be described herein. The reticle removing method includes providing the reticle removing apparatus 300. Then, the reticle removing module 320 is moved into the reticle library 100 in the first direction D1 to remove the reticle 50 in the reticle library 100. In detail, before moving the reticle removing module 320 into the reticle library 100, a position of the reticle removing module 320 in the second direction D2 may be adjusted to level at the one of the supporting layers 112. For example, while removing the reticle 50 in the uppermost supporting layer 112, the position of the reticle removing module 320 in the second direction D2 may be adjusted to level at the uppermost supporting layer 112. The manner to adjust the position of the reticle removing module 320 in the second direction D2 is adjusting the position of the base 321 in the second direction D2. The manner to adjust the position of the base 321 in the second direction D2 has been described above, so detailed description is omitted herein. After, the gripper 322 is moved into the reticle library 100 in the first direction D1, and the gripper 322 is under the reticle 50. Then, the gripper 322 may be slightly lifted up with the base 321 so as to grip the reticle 50. Afterwards, the gripper 322 is moved outside the reticle library 100 in the first direction D1 so as to remove the reticle 50 in the reticle library 100.

In the present embodiment, the operator can use the reticle removing module 320 to smoothly remove the reticle 50 stuck in the reticle library 100 so as to prevent the reticle 50 from being impacted or the like. Therefore, the reticle removing apparatus 300 and the reticle removing method can prevent the reticle 50 from being damaged during the manual removal. Moreover, because the track elements 324 may be pivoted to the fasteners 314, the track elements 324 can be rotated to be substantially parallel to the fixed elements 312 when the reticle removing apparatus 300 is not needed. Therefore, the space for receiving the reticle removing apparatus 300 is reduced.

FIG. 5 is a schematic three-dimensional view of a reticle removing apparatus according to another embodiment of the present invention. Referring to FIG. 5, the reticle removing apparatus 300a is similar to the reticle removing apparatus 300, and the difference is that the bracket 310a of the reticle removing apparatus 300a further includes a platform 331 and a reticle holder 332. The platform 331 may be disposed between the fixed elements 312 and the reticle holder 332 is disposed on the platform 331. When the reticle in the reticle library is removed outside the reticle library, the reticle can be put on the reticle holder 332. The platform 331 also can be pivoted to the fixed elements 312 by the fasteners 314 as shown in FIG. 4. Moreover, the reticle removing apparatus 300a further includes a suction module 340. The suction module 340 includes a suction element 342 and a vacuum tank 344 coupled to the suction element 342. The suction element 342 is configured for sucking a reticle in the exposure apparatus but outside the reticle library.

In summary, the operator can use the reticle removing module of the reticle removing apparatus to smoothly remove the reticle stuck in the reticle library so as to prevent the reticle from being damaged during the manual removal. Moreover, due to using the reticle removing apparatus to remove the reticle stuck in the reticle library, the reticle removing method can prevent the reticle from being damaged during the manual removal.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A reticle removing apparatus adapted to remove a reticle in a reticle library of an exposure apparatus, the reticle removing apparatus comprising:
a bracket; and
a reticle removing module movably coupled to the bracket, wherein the reticle removing module is configured to be moved into the reticle library in a first direction to remove the reticle in the reticle library.

2. The reticle removing apparatus according to claim 1, wherein the reticle removing module comprises:
a base movably coupled to the bracket and provided with a sliding track; and
a gripper movably coupled to the base, the gripper is adapted to be slid along the sliding track into the reticle library to remove the reticle in the reticle library.

3. The reticle removing apparatus according to claim 2, wherein the bracket comprises two opposite fixed elements, the base comprises two opposite track elements respectively coupled to the two fixed elements, and the sliding track is provided by the track elements.

4. The reticle removing apparatus according to claim 3, wherein the gripper comprises:
two arms movably coupled to the two track elements respectively and configured to be slid along the sliding track into the reticle library to remove the reticle in the reticle library; and
a connection part connected to the two arms.

5. The reticle removing apparatus according to claim 4, wherein each of the arms is provided with at least a roller coupled to the corresponding sliding track.

6. The reticle removing apparatus according to claim 4, wherein a first end of each of the arms is provided with a stop block, the connection part is connected to a second end of each of the two arms, and the first end is opposite to the second end.

7. The reticle removing apparatus according to claim 3, wherein the reticle library comprises a plurality of supporting layers stacked in a second direction, each of the supporting layers is configured for supporting the reticle, and the base is suitable to be moved in the second direction to level at one of the supporting layers.

8. The reticle removing apparatus according to claim 7, wherein each of the fixed elements is a fixed column parallel to the second direction, the bracket further comprises two fasteners respectively coupled to the fixed elements, and each of the track elements is coupled to the corresponding fixed element through one of the fasteners.

9. The reticle removing apparatus according to claim 8, wherein each of the track elements is pivoted to the corresponding fastener.

10. The reticle removing apparatus according to claim 1, wherein the bracket further comprises:
a platform; and
a reticle holder disposed on the platform.

11. The reticle removing apparatus according to claim 1, further comprising a suction module, wherein the suction module comprises:
a suction element configured for sucking a reticle in the exposure apparatus but outside the reticle library; and
a vacuum tank coupled to the suction element.

12. The reticle removing apparatus according to claim 1, wherein the reticle library comprises a plurality of supporting layers stacked in a second direction, the bracket comprises a plurality of track layers stacked in the second direction and respectively leveled at the supporting layers, and the reticle removing module is movably coupled to one of the track layers.

13. The reticle removing apparatus according to claim 12, wherein the bracket is configured to be connected with the reticle library to communicate the track layers with the supporting layers.

14. The reticle removing apparatus according to claim 13, further comprising a fixing unit configured to fix the bracket to the reticle library.

15. The reticle removing apparatus according to claim 12, wherein the reticle removing module comprises:
a base movably coupled to one of the track layers and adapted to be slid along the corresponding track layer; and
a gripper coupled to the base and adapted to be slid with the base and into the reticle library to remove the reticle in the reticle library.

16. The reticle removing apparatus according to claim 15, wherein the base comprises two first arms and a first connection part connected to the two first arms, the gripper comprises two second arms and a second connection part connected to the two second arms, and each of the second arms is separably coupled to the corresponding first arm.

17. The reticle removing apparatus according to claim 16, wherein the base further comprises a first handle connected to the first connection part, and the gripper further comprises a second handle connected to the second connection part.

18. The reticle removing apparatus according to claim 16, wherein each of the first arms is provided with at least a coupling track and each of the second arms is provided with at least a pillar coupled to the coupling track.

19. A reticle removing method adapted to remove a reticle in a reticle library of an exposure apparatus, the reticle removing method comprising:
providing a reticle removing apparatus, the reticle removing apparatus comprising a bracket and a reticle removing module movably coupled to the bracket; and
moving the reticle removing module into the reticle library in a first direction to remove the reticle in the reticle library.

20. The reticle removing method according to claim 19, wherein the reticle library comprises a plurality of supporting layers stacked in a second direction, each of the supporting layers is configured for supporting the reticle, and the reticle removing method further comprises:
adjusting a position of the reticle removing module in a second direction to level at the one of the supporting layers before moving the reticle removing module into the reticle library.
